(19) United States
(12) Patent Application Publication
(10) Pub. No.: US 2011/0131515 A1
(43) Pub. Date: Jun. 2, 2011

(54) IN-VEHICLE DISPLAY SYSTEM

(75) Inventors: Takatsugu ONO, Kobe-shi (JP); Noriyuki KAMIKAWA, Kobe-shi (JP); Tatsuki KUBO, Kobe-shi (JP)

(73) Assignee: FUJITSU TEN LIMITED, KOBE-SHI (JP)

(21) Appl. No.: 12/892,272

(22) Filed: Sep. 28, 2010

(30) Foreign Application Priority Data
Nov. 27, 2009 (JP) 2009-269807

(51) Int. Cl. G06F 3/048

(52) U.S. Cl. 715/764

(57) ABSTRACT

The receiver respectively receives an instruction by a first operation to select a first item from amongst a plurality of first items displayed on a display unit, an instruction by a second operation to determine the first item selected from amongst the plurality of first items, and an instruction by a third operation to display a plurality of second items representing commands relating to the first item selected from amongst the plurality of first items.

### BACKGROUND OF THE INVENTION

1. Field of the Invention

The invention relates to an in-vehicle display system for installation in a vehicle to provide displayed information to a user.

2. Description of the Background Art

Conventionally, in-vehicle display systems, such as a navigation system, installed in vehicles including automobiles, to provide various types of information to users (typically drivers) have been known.

Due to a relatively short period of time for operation in many cases, for example, while a vehicle is stopping, such in-vehicle display systems are required to enable drivers to give desired instructions intuitively and speedily. Therefore, a touch-screen system that allows users to give various types of instructions by touching command buttons has been commonly adopted for the in-vehicle display systems recently.

When a touch-screen system, like the one mentioned above, is adopted for an in-vehicle display system, the display of the system needs to be placed at a position within the reach of the user. As a result, the display needs to be placed in a limited area and may not be placed at a position preferable.

For example, in order to reduce a moving distance of the line of sight of a driver who is about to see the display during driving, it is desired to place the display on the instrument panel at a center between opposite sides of the instrument panel in an area close to the front windshield of the vehicle. However, the driver cannot reach the area close to the front windshield on the instrument panel, so that the display cannot be disposed in the area if a touch-screen system is adopted for the display.

The adoption of a touch-screen system adds a restriction to the location of the display, which leads to an improvement that the display is separated from an operating member so that the display is disposed at an easy-to-see place for the driver and the operating member is disposed at an easy-to-operate place. Such a display system needs to allow a user to give desired instructions intuitively and speedily only by operating the operating member without a touch-screen system.

### SUMMARY OF THE INVENTION

According to one aspect of this invention, an in-vehicle display system for installation in a vehicle includes: a display unit for displaying information; an operation unit disposed separately from the display unit and allowing for three types of user operations including a first operation, a second operation and a third operation; and a receiver for receiving an instruction given by a user based on displayed contents displayed on the display unit and the user operations made with the operation unit. The receiver of the in-vehicle display system respectively receives: an instruction by the first operation to select a first item from amongst a plurality of first items displayed on the display unit; an instruction by the second operation to determine the first item selected from amongst the plurality of first items; and an instruction by the third operation to display a plurality of second items representing commands relating to the first item selected from amongst the plurality of first items.

When the first item is specified from amongst the plurality of first items, an operation that displays a plurality of second items representing commands related to the first item selected is available. As a result, the user can easily specify one of the commands related to the first item. Therefore, even when the display unit is disposed in a cabin separately from the operation unit, high operability of the in-vehicle display system is ensured.

According to another aspect of this invention, the display unit displays the plurality of second items in animation in which the plurality of second items move into a screen of the display unit from one direction. The display unit cancels the display of the plurality of second items, in response to a direction operation in the one direction of the operation unit, after displaying the plurality of second items.

Since the plurality of second items appear and move into the screen from one direction of the screen in animation, the user can intuitively understand an operation to cancel the display of the plurality of second items.

According to another aspect of this invention, the first operation is a turning operation, the second operation is a pressing operation and the third operation is a direction operation.

The user can intuitively implement an operation because a command assigned to each operation matches the sense of the user.

Moreover, according to another aspect of this invention, the in-vehicle display system further includes a detector for detecting a touch of the user to the operation unit, and when the detector detects the touch of the user and there is no operation of the operation unit for more than a predetermined period of time, the display unit displays an operation guide that shows available operations.

Since the operation guide is displayed for a user inexperienced in an operation of the operation unit, the user can easily understand a method of his/her desired operation and high operability of the operation unit is ensured. On the other hand, since the operation guide is not displayed until the predetermined period of time passes after the user touch is detected, the operation guide is not displayed for a user experienced in the operation. Therefore, the user experienced in the operation does not feel frustrated.

Therefore, an object of the invention is to provide an in-vehicle display system having high operability even when a display unit is disposed separately from an operation unit in a cabin.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a block diagram showing a configuration outline of an in-vehicle display system;

FIG. 2 shows an exemplary placement of a display and an operation unit disposed in a cabin;

FIG. 3 is an external perspective view of a main controller;

FIG. 4 is a sectional view of a main controller;

FIG. 5 is a diagram showing an outline of a hierarchical category structure to which audio data are sorted;

FIG. 6 is a diagram showing a display example of the screen of the display for specifying an item in a general attribute category;

FIG. 7 is a diagram showing a display example of the screen of the display for specifying an item in a general attribute category;

FIG. 8 is a diagram showing a display example of the screen of the display for specifying an item in a sub-attribution category;

FIG. 9 is a diagram showing a display example of the screen of the display for specifying an item in a sub-attribution category;

FIG. 10 is a diagram showing a display example of the screen of the display for specifying an item in a song title category;

FIG. 11 is a diagram showing an edit screen displayed on a display;

FIG. 12 is a diagram showing an edit screen displayed on a display;

FIG. 13 is a diagram showing an example of an animation related to an edit screen;

FIG. 14 is a diagram showing an operation panel displayed on a display;

FIG. 15 is a diagram showing a source panel displayed on a display;

FIG. 16 is a diagram showing a flow of receiving a user instruction based on a user operation;

FIG. 17 is a diagram showing an operation guide displayed on a display;

FIG. 18 is a diagram showing an operation guide displayed on a display;

FIG. 19 is a diagram showing a process flow for displaying an operation guide;

FIG. 20 is a diagram showing a map image displayed on a display in a navigation mode;

FIG. 21 is a diagram showing a scale change panel displayed on a display;

FIG. 22 is a diagram showing a command menu panel displayed on a display;

FIG. 23 is a diagram showing an operation guide displayed on a display in a navigation mode; and

FIG. 24 is a diagram showing an operation unit is disposed on the steering wheel.

### DESCRIPTION OF THE EMBODIMENTS

Hereinbelow, an embodiment of the invention is described with reference to the attached drawings.

<1. Configuration>

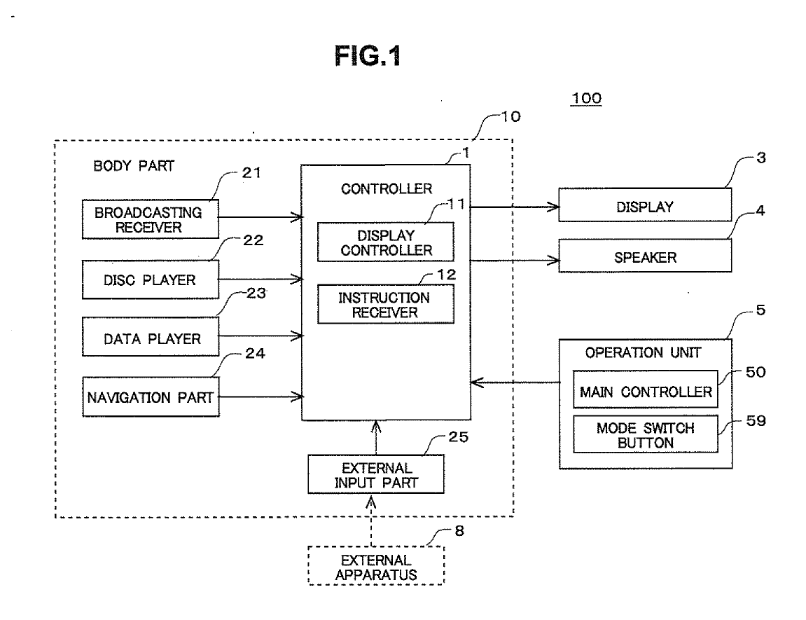

FIG. 1 is a block diagram showing a configuration outline of an in-vehicle display system 100 that is an embodiment of this invention. The in-vehicle display system 100 is for installation in a vehicle (a car in this embodiment) and provides displayed information to a user such as a driver in the cabin of the vehicle. The in-vehicle display system 100 includes an audio function and a navigation function as main functions, and is capable of displaying information such as the title of a song to be played by the audio function and a map image and the like used for navigation.

As shown in FIG. 1, the in-vehicle display system 100 includes a body part 10 that implements various processes, a display 3 that displays various types of information, a speaker 4 that outputs various sounds, and an operation unit 5 with which a user operate the system.

The body part 10 is configured as an ECU and disposed at a predetermined position that cannot be seen from the cabin. The body part 10 includes a controller 1 that controls the entire system of the in-vehicle display system 100, a broadcasting receiver 21 that receives broadcast signals, a disc player 22 that plays a disc, a data player 23 that plays digital audio data, a navigation part 24 that provides a navigation function, and an external input part 25 that inputs signals from an external apparatus 8. In this explanation, “audio data” includes music data.

By receiving broadcast signals of digital terrestrial television broadcasting as well as radio broadcasting such as AM and FM, the broadcasting receiver 21 obtains video and audio signals based on the broadcast signals. The audio signals obtained by the broadcasting receiver 21 are output from the speaker 4, and the video signals obtained by the broadcasting receiver 21 are displayed on the display 3.

The disc player 22 reads a record written in a disc media such as CD, DVD and BD to obtain audio signals and/or video signals. The audio signals obtained by the disc player 22 are output from the speaker 4 and the video signals obtained by the disc player 22 are displayed on the display 3.

The data player 23 that includes a hard disc reads and decodes digital audio data such as MP3 stored beforehand in the hard disc to obtain playable audio signals. The audio signals obtained by the data player 23 are output from the speaker 4.

Displaying a map image based on a current location of a vehicle, the navigation part 24 provides route guidance showing a route to a destination when the destination is set. The navigation part 24 that includes a GPS obtains the current location of the vehicle via the GPS. The map image that includes a route to the destination is displayed on the display 3, and voice route guidance is output from the speaker 4.

The external input part 25 inputs the audio signals from the external apparatus 8 (for example, a mobile music player and the like possessed by the user) of the in-vehicle display system 100 and outputs them to the controller 1. As a result, the audio signals obtained from the external apparatus 8 are output from the speaker 4 of the vehicle.

The controller 1 is configured as a computer including a CPU, a RAM, a ROM and the like. A variety of control functions are implemented by arithmetic processing performed by the CPU in accordance with a program configured as firmware stored in the ROM beforehand. A display controller 11 and an instruction receiver 12 shown in FIG. 1 are a portion of the functions of the controller 1 implemented as described above.

The display controller 11 performs control related to the displaying on the display 3. The instruction receiver 12 receives a user instruction based on a user operation made with the operation unit 5 and thus controls the entire system to behave according to the user instruction.

The display 3 of this embodiment does not have a touch-screen function. When the user gives a variety of instructions to the in-vehicle display system 100, he/she operates the operation unit 5, looking at an operation screen displayed on the display 3. Therefore, the instruction receiver 12 understands the user instruction, based on the displayed contents input from the display controller 11 as well as a user operation made with the operation unit 5.

The display 3, the speaker 4, and the operation unit 5 are electrically connected to the body part 10. As a result, the display 3 and the speaker 4 work under the control of the controller 1, and the user operation made with the operation unit 5 is input to the controller 1 as signals.

The operation unit 5 includes a main controller 50 and a mode switch button 59. A user uses mainly the main controller 50 to give a variety of instructions to the in-vehicle display system 100. On the other hand, the user uses the mode switch button 59 to change an operation mode of the in-vehicle display system 100. The operation modes of the in-vehicle display system 100 includes an audio mode for giving an instruction related to the audio function and a navigation mode for giving an instruction related to the navigation function. By pressing the mode switch button 59, the operation mode changes from the audio mode to the navigation mode or from the navigation mode to the audio mode.

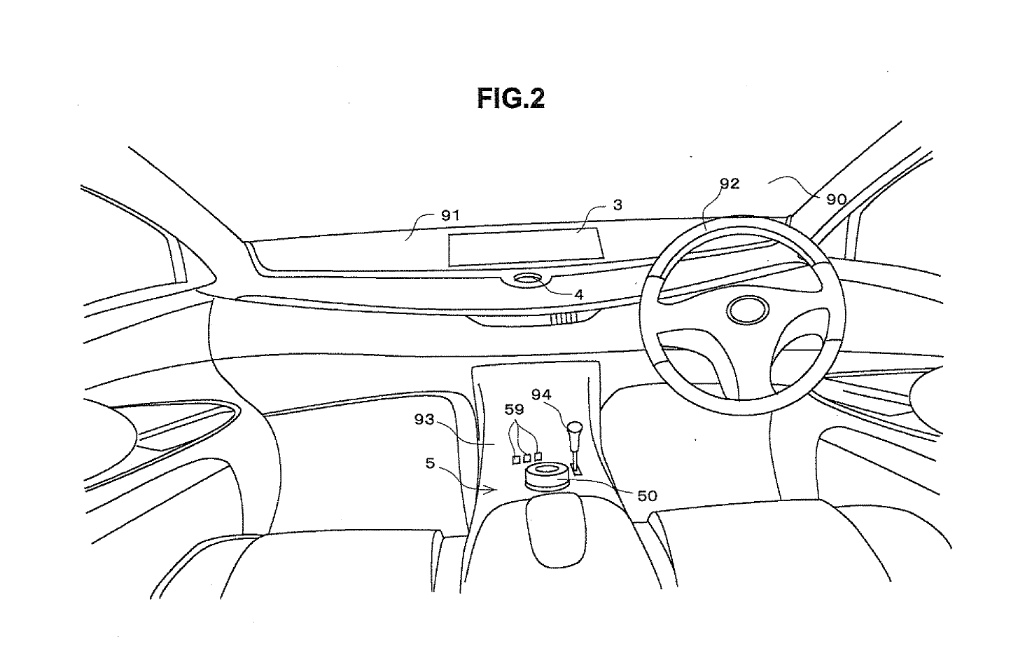

The display 3, the speaker 4, and the operation unit 5 are respectively disposed at their optimal positions in the cabin, separately from the body part 10. FIG. 2 shows an exemplary placement of the display 3, the speaker 4, and the operation unit 5 disposed in the cabin. As shown in FIG. 2, the display 3 is disposed on an instrument panel 91 at a center between opposite sides of the instrument panel 91 in an area close to the front windshield 90 in order to reduce the moving distance of the line of sight of a driver who is about to see the display 3. Moreover, the speaker 4 is disposed on an instrument panel 91 at a center between opposite sides of the instrument panel 91 in an area close to the display 3.

The operation unit 5 is disposed close to a shift lever 94 on a center console 93 of the vehicle. The main controller 50 is disposed on a rear side of the shift lever 94 and the mode switch button 59 is disposed near the main controller 50. The vehicle in this embodiment is a car with a steering wheel on the right side. Therefore, during driving, the driver operates the shift lever 94 with the left hand, if needed, while operating a steering wheel 92. Since the operation unit 5 is disposed in proximity to the shift lever 94, the driver can operate the operation unit 5 with the left hand at a driving position.

The main controller 50 of the operation unit 5 includes an operating member allowing for all operations, only with the left hand, of a turning operation, a pressing operation (push operation), and a direction operation (slide operation) that is the operation of sliding the main controller 50 to a direction.

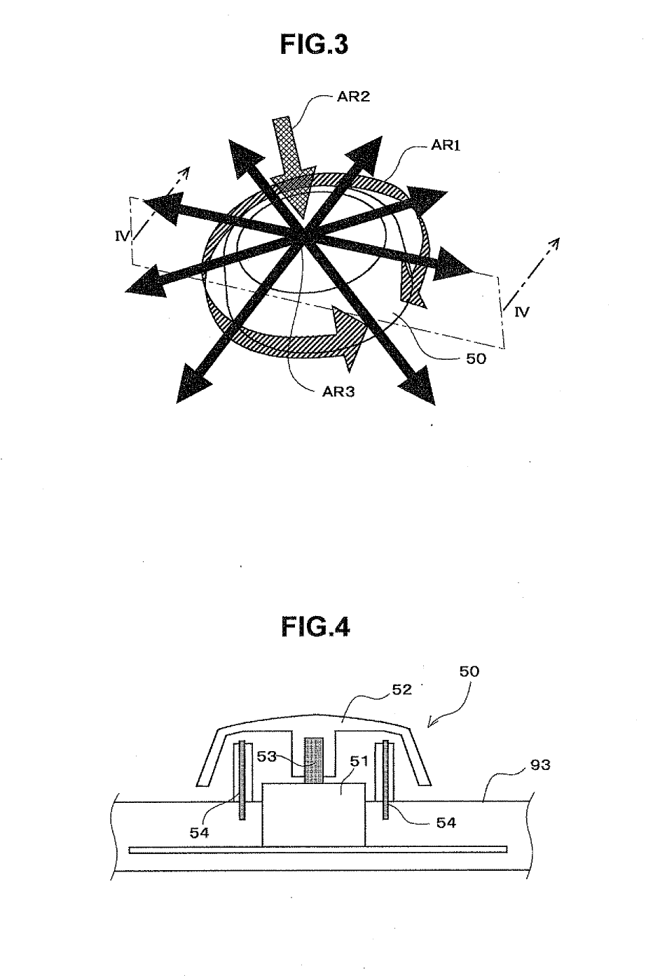

FIG. 3 is an external perspective view of the main controller 50. As shown in FIG. 3, the main controller 50 is shaped almost like a circular cylinder and is of a size that is right for a user to cover and hold with one hand.

The main controller 50 can be turned in directions shown by an arrow AR1 in FIG. 3. When the main controller 50 is turned in one of the directions, a signal representing the turning operation and a signal representing the direction (counterclockwise or clockwise) of the turning operation are input to the controller 1. Moreover, the main controller 50 can be pushed in a direction shown by an arrow AR2 in FIG. 3. When the main controller 50 is pushed, a signal representing the pressing operation is input to the controller 1. Furthermore, the main controller 50 is slidable in the eight directions shown by an arrow AR3 in FIG. 3. When the main controller 50 is slid, a signal representing the direction operation and a signal representing a direction (orientating) of the slide are input to the controller 1.

FIG. 4 is a sectional view of the main controller 50 taken along the line IV-IV in FIG. 3. As shown in FIG. 4, the main controller 50 includes a base 51 embedded in the center console 93, a holding part 52 that a user holds to operate the main controller 50, and a connection axis 53 that physically connects the base 51 to the holding part 52. Each of physical movements (turn, press, and slide) of the holding part 52 that the user holds for operation is transmitted to the base 51 via the connection axis 53. The base 51 converts the each of physical movements transmitted into an electric signal and inputs it to the controller 1.

A touch sensor 54 is disposed within the holding part 52, extending along the circumference of the holding part 52. The touch sensor 54 is a sensor for detecting a touch of the user to the main controller 50 (more concretely, the holding part 52). One example of the touch sensor 54 is an electrostatic sensor that detects a touch of a user based on a slight change of capacitance which is caused by a user hand coming close to the touch sensor 54.

<2. Audio Mode>

<2-1. Hierarchical Category Structure>

Next, the audio mode will be explained. The in-vehicle display system 100 is capable of playing audio signals and video signals from various sources such as a hard disc (HDD), a disc media (DISC), broadcasting (AM, FM, TV) and external input (AUX). Therefore, a user needs to specify a source to be played, and then specify a piece of music or a broadcasting station to be played. The audio data of many pieces of music can be stored in a hard disc. Therefore, especially when playing audio data stored in a hard disc, the user needs to specify audio data to be played from the audio data of many pieces of music.

In the in-vehicle display system 100, the audio data of many pieces of music that are candidates for playing is sorted in a hierarchical category structure according to the attributes of the audio data, which allows the user to easily specify a part of the audio data of his/her desired piece of music from the entire audio data of many pieces of music.

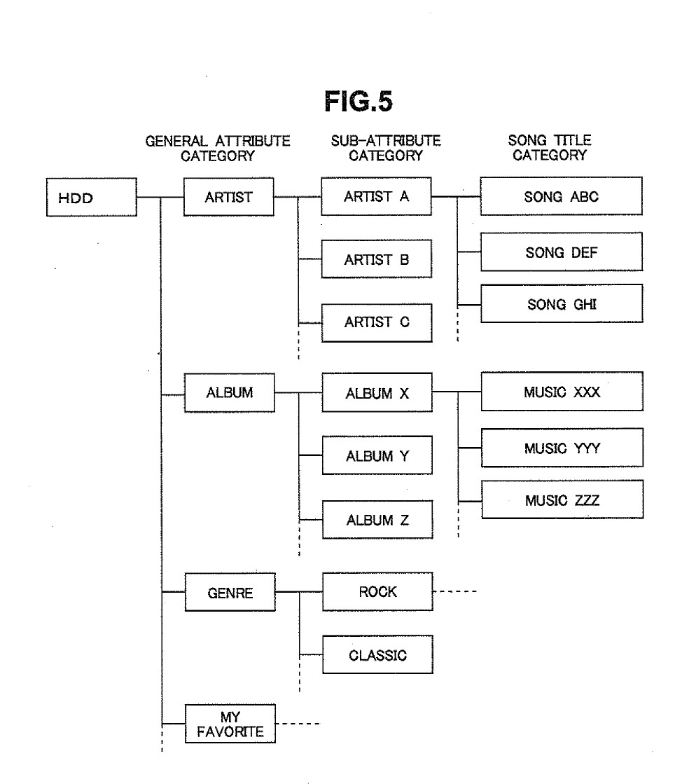

FIG. 5 is a diagram showing an outline of a hierarchical category structure to which audio data stored in a hard disc are sorted. As shown in FIG. 5, the audio data are sorted in the three categories including a general attribute category, a sub-attribute category, and a song title category. The general attribute category includes items of relatively general attributes such as “Artist,” “Album,” Genre,” “My favorite,” and the like. The sub-attribute category is a hierarchical category lower than the general attribute category and includes items of relatively more specific attributes of each item included in the general attribute category. Concretely, in a case of the item “Artist” in the general attribute category, for example, items of its lower sub-attribute category may include artist names such as “Artist A” and “Artist B.” In a case of the item “Album” in the general attribute category, for example, items of its lower sub-attribute category may include album names such as “Album X” and “Album Y.” In a case of the item “Genre” in the general attribute category, for example, items of its lower sub-attribute category may include music genres such as “Rock” and “Classic.”

The song title category is lower than the sub-attribute category and includes song titles, each of which corresponds to its audio data. In a case of the item “Artist A” in the sub-attribute category, for example, items of its lower song title category may include song titles of Artist A. In a case of the item “Album X” in the sub-attribute category, for example, items of its lower song title category may include the titles included in the Album X.

By specifying an item in each category of such a hierarchical category structure via an operation of the main controller 50, the user can specify a part of music data having desired attributes, to play. Hereinbelow, the operation to specify an item in each category will be explained.

<2-2. Operation of Specifying an Item>

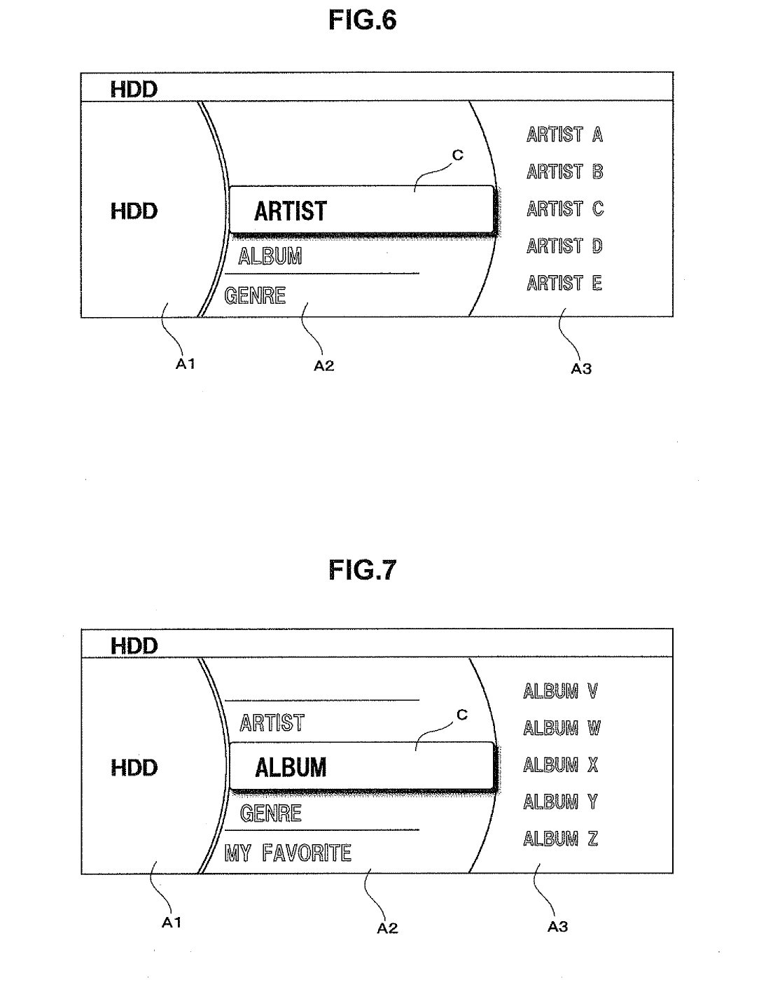

FIG. 6 is a diagram showing a display example of the screen of the display 3 for specifying an item in the general attribute category. As shown in FIG. 6, the screen of the display 3 is divided in three areas of a left area A1, a center area A2, and a right area A3 by arc dividing lines extending upward from the bottom of the screen. A source specified is displayed in the left area A1. In FIG. 6, “HDD” representing a hard disc is displayed because a hard disc is specified as the source of music data.

A plurality of items which are candidates for specifying are displayed in the center area A2. As FIG. 6 shows a case where an item in the general attribute category will be specified, the items displayed are the plurality of items in the general attribute category, such as “Artist,” “Album,” “Genre,” and “My favorite.” Out of the plurality of items to be candidates for specifying, only a predetermined number of items (in this embodiment, up to five items) are displayed in the center area A2 due to an area size restriction. In this regard, hidden items of the plurality of items to be candidates for specifying can be displayed on the screen by the turning operation of the main controller 50. Moreover, a cursor C is located at a center between the top and the bottom of the center area A2 to select an item located at the vertical center, of the plurality of items to be candidates for specifying. By the turning operation of the main controller 50, the items are moved up or down. Therefore, by the turning operation, the cursor C is moved up or down relatively to the items displayed so that an item selected by the cursor C can be changed.

Concretely, by a clockwise turn of the main controller 50, each of the items is moved upward, causing a hidden item to be displayed on a bottom line and, at the same time, an item having been displayed on a top line to be hidden. By this turning operation, the cursor C is practically moved to a next item below. For example, a clockwise turn in the state shown in FIG. 6 causes the items of “Artist,” “Album,” and “Genre” shown in FIG. 6 to move upward, and the item “My favorite” to be additionally displayed as shown in FIG. 7. The item “Artist” is selected with the cursor C in FIG. 6, but the cursor C has moved onto the item “Album” and the item “Album” is selected by the cursor C in FIG. 7. Contrarily, by a counterclockwise turn of the main controller 50, each of the items is moved downward and the cursor C is moved to a next item above. In such a way, the instruction receiver 12 receives an instruction by the turning operation of the main controller 50 to select an item (“selection instruction”).

Items displayed in the right area A3 are the items in the sub-attribute category that is a lower category of the item selected by the cursor C. Therefore, when the item selected by the cursor C is changed by the turning operation, the items displayed in the right area A3 are also changed.

By implementing the pressing operation of the main controller 50, the item selected by the cursor C is determined. In other word, the instruction receiver 12 receives an instruction by the pressing operation of the main controller 50 to determine an item. By this operation, an item is specified from amongst the plurality of items to be candidates for specifying in the general attribute category. After the item is specified, the screen is changed to specify an item in the sub-attribute category that is a lower category of the item specified in the general attribute category.

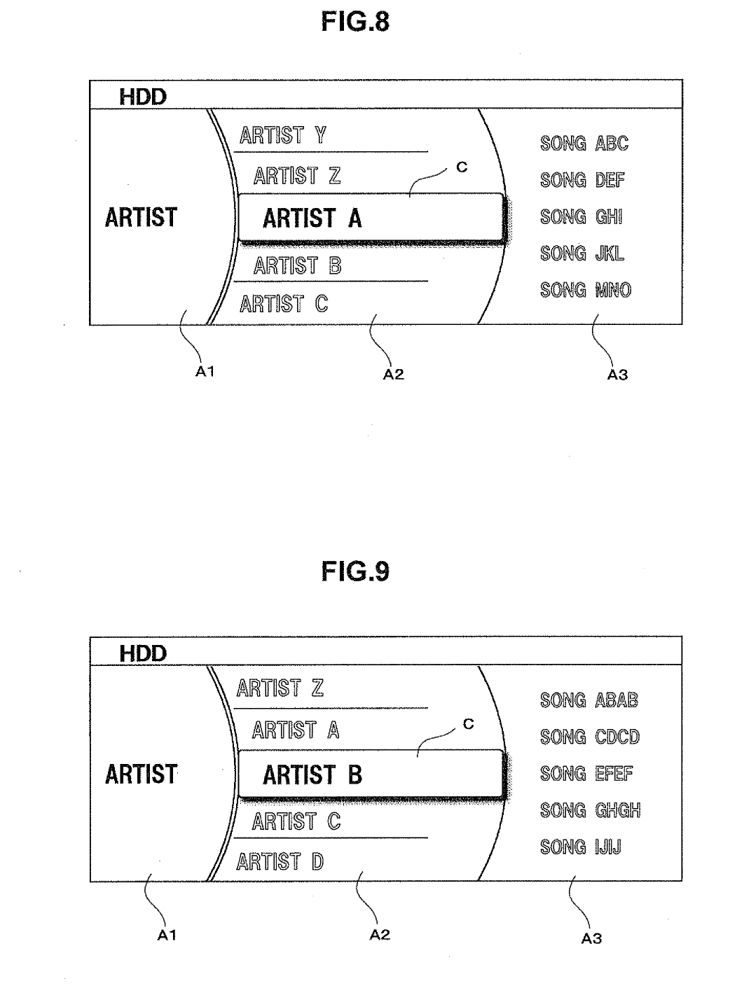

FIG. 8 is a diagram showing a display example of the screen of the display 3 for specifying an item in the sub-attribution category. FIG. 8 shows an example where the item “Artist” in the general attribute category is specified (the pressing operation is implemented in the state shown in FIG. 6).

For specifying an item in the sub-attribute category, too, a plurality of items to be candidates for specifying are displayed in the center area A2. Since FIG. 8 shows a case where an item will be specified from amongst the plurality of items in the sub-attribute category of the item “Artist” specified, items displayed in the center area A2 are the plurality of artist names, such as “Artist A” and “Artist B.”

An item displayed in the left area A1 is the item specified in the general attribute category that is the immediate upper category. In this case, the item “Artist” specified in the general attribute category is displayed. Items displayed in the right area A3 are items in the song title category that is the lower category of the item selected by the cursor C.

For specifying an item in the sub-attribute category, too, the items displayed in the center area A2 are changed by the turning operation of the main controller 50, as in the case of the general attribute category. By this operation, the cursor C is moved relatively to the items displayed so that the item selected by the cursor C can be changed. For example, a clockwise turn of the main controller 50 in the state shown in FIG. 8 changes the state to the one shown in FIG. 9, and the item selected by the cursor C is changed from the item “Artist A” to the item “Artist B.”

For specifying an item in the sub-attribute category, the plurality of items to be candidates for specifying are listed in circulation, with the first item listed next to the last item. In the example shown in FIG. 8, as for the order of displaying artist names as items, “Artist A” is the first item and “Artist Z” is the last item to display. In this case, the item “Artist Z” is listed immediately above the item “Artist A.” By a counterclockwise turn of the main controller 50 in the state shown in FIG. 8, the cursor C is moved to the last item “Artist Z.” As described above, since the plurality of items to be candidates for specifying are listed to circulate, the user can easily select an item even listed in the latter half in a displaying order.

Also in this case, the item selected by the cursor C is determined by the pressing operation of the main controller 50. By this operation, an item is specified from amongst the plurality of items to be candidates for specifying in the sub-attribute category. Once the item is specified, the screen is changed to specify an item in the song title category at a lower level than the level of the item specified in the sub-attribute category.

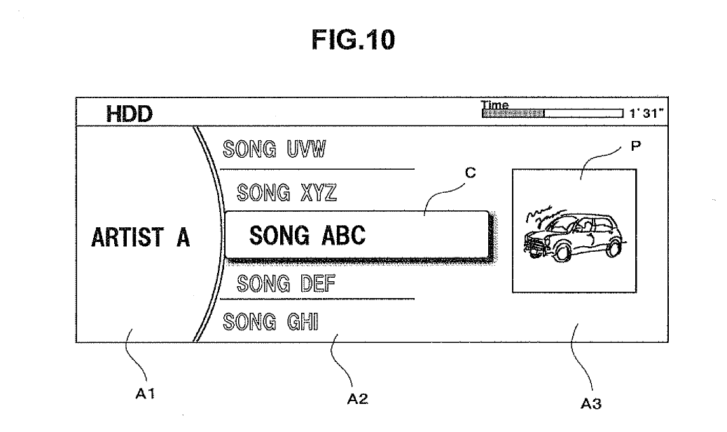

FIG. 10 is a diagram showing a display example of the screen of the display 3 for specifying an item in the song title category. FIG. 10 shows an example where the item “Artist A” in the sub-attribute category is specified (the pressing operation is implemented in the state shown in FIG. 8).

For specifying an item in the song title category, too, a plurality of items to be candidates for specifying are displayed in the center area A2. Since FIG. 10 is a case where an item will be specified from amongst the plurality of items in the song title category of the item “Artist A” specified, items displayed in the center area A2 are the plurality of song titles related to Artist A. In the example shown in FIG. 10, the song titles such as “Song ABC” and “Song DEF” are displayed in the center area A2. In this case, too, the plurality of items to be candidates for specifying are listed to circulate.

The item displayed in the left area A1 is the item specified in the sub-attribute category that is the immediate upper category of the song title category. In this case, the item “Artist A” specified in the sub-attribute category is displayed. A picture P of a CD jacket corresponding to the item selected by the cursor C is displayed in the right area A3.

For specifying an item in the song title category, too, the items displayed in the center area A2 are changed by the turning operation of the main controller 50. By this operation, the cursor C is moved relatively to the items displayed so that the item selected by the cursor C can be changed.

In this case, too, the item selected by the cursor C is specified by the pressing operation of the main controller 50. By this operation, an item is specified from amongst the plurality of items to be candidates for specifying in the song title category. Once the item is specified, the music data of the song title corresponding to the item specified is played. In other words, the music data is read from the hard disk and decoded, and audio signals obtained by decoding the music data is output from the speaker 4.

By implementing an operation like the one mentioned above, a user can specify audio data desired to play, out of a huge collection of audio data, and can make play the audio data specified. An item can be selected by the turning operation of the main controller 50, and the item selected can be determined by the pressing operation of the main controller 50. Therefore, an item can be specified intuitively and speedily, and high operability is ensured.

In the example mentioned above, playing of audio data starts when an item in the song title category is determined. In this case, it is set to continue playing audio data specified by a last operation of specifying an item until another item is determined. On the other hand, it may also be set to start playing audio data corresponding to an item when the item is selected by the cursor C. In such a setting, a user can identify a song title by listening to the sound played after implementing the turning operation. Therefore, the user can specify audio data desired without looking at the display 3.

In this case, however, only introductions of a plurality of pieces of music are continuously played when a user implements the turning operation relatively fast, occasionally. The user is probably frustrated with such continuous playing of the introductions. Therefore, it may be set to start playing a part of the audio data corresponding to an item selected by the cursor C when a predetermined period of time (one second, for example) passes after the item is selected. Moreover, a start timing of playing audio data may be set at either a time when an item is determined or a time when an item is selected by the cursor C, by the user.

<2-3. Operation of Displaying a Command>

As mentioned above, a user implements the turning operation and the pressing operation of the main controller 50 to specify an item included in the hierarchical category structure. For specifying an item, a variety of commands relating to an item selected by the cursor C are displayed by a direction operation to the right of the main controller 50.

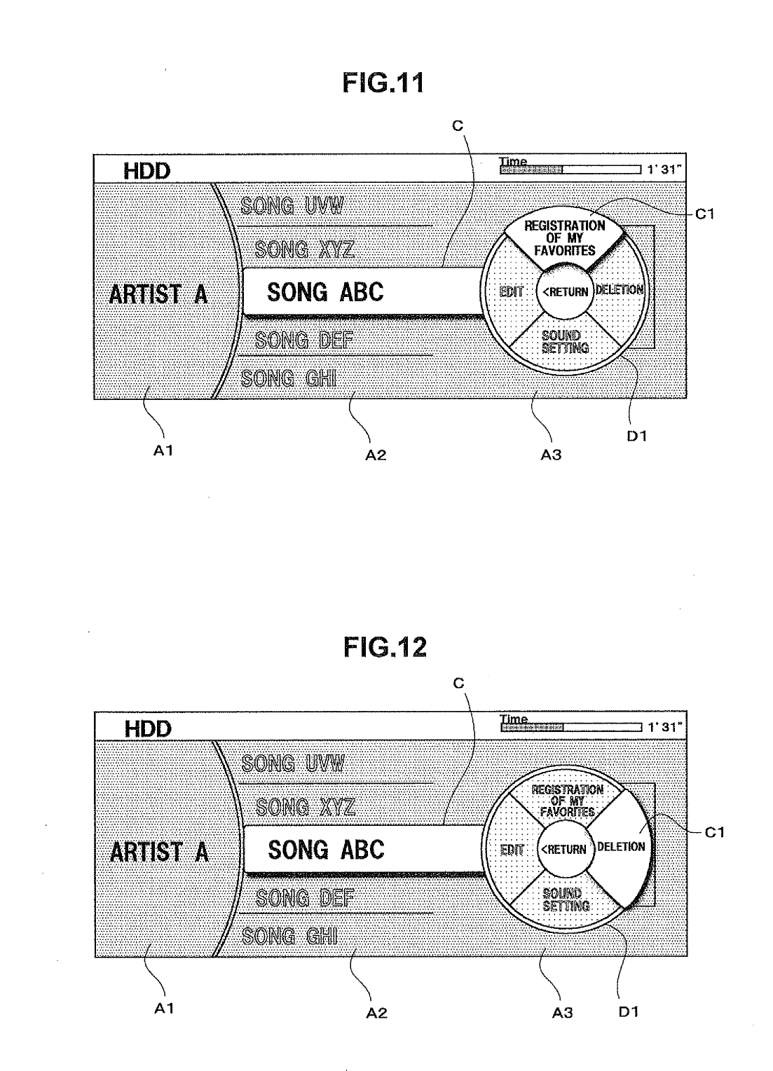

FIG. 11 is a diagram showing a display example on the screen of the display 3 when the direction operation to the right of the main controller 50 is implemented for specifying an item in the song title category.

In this case, the brightness of areas other than an item selected by the cursor C is reduced to emphasize the item selected. At the same time, a command panel D1 including a plurality of items representing commands relating to the item selected by the cursor C is displayed in the right area A3 by the direction operation to the right. The command panel D1 is also referred to as an “edit panel.”

The command panel D1 is shaped like a circle. The command panel D1 is divided in a plurality of item sections, each of which is sector-shaped, by a plurality of lines extending from a center of the command panel D1, and the plurality of item sections are circularly disposed. An item representing a command is disposed in each of the item sections. The term “command” here means an executable user instruction related to the audio data of an item (in FIG. 11, “song ABC”) selected by the cursor C in the song title category. In the example shown in FIG. 11, the command panel D1 has four items representing commands of “Registration of my favorites” for registering audio data on a predetermined list, “Deletion” for deleting audio data from the predetermined list, “Edit” for editing a song title and/or an attribute of audio data on the predetermined list, and “Sound setting” for setting sound quality (equalizer, balance between right and left or front and back) of audio data.

Each item representing a command displayed on the command panel D1 is specified in the same method as described above for specifying an item in the hierarchical structure category. Concretely, a cursor C1 is moved by the turning operation of the main controller 50, and an item selected by the cursor C1 is determined by the pressing operation of the main controller 50.

The cursor C1 is moved to a next item on the right on the command panel D1 by a clockwise turn of the main controller 50 and moved to a next item on the left on the command panel D1 by a counterclockwise turn of the main controller 50. For example, the clockwise turn of the main controller 50 changes the state shown in FIG. 11 to the state shown in FIG. 12 with the cursor C1 moving from “Registration of my favorites” to “Deletion.”

By the pressing operation of the main controller 50, the item selected by the cursor C1 is determined. As a result, a command represented by the item determined is received by the instruction receiver 12 and executed by the controller 1. For example, the pressing operation with the item “Deletion” selected by the cursor C1 deletes the audio data of an item selected by the cursor C from a hard disc.

Displaying of the command panel D1 is cancelled by a direction operation to the left, opposite to a direction operation to the right for displaying the command panel D1. In this case, a command represented by an item selected is cancelled and not executed.

The command panel D1 is displayed by the direction operation to the right as mentioned above, and the command panel D1 appears in animation, moving on the screen of the display 3 from the left side of the screen.

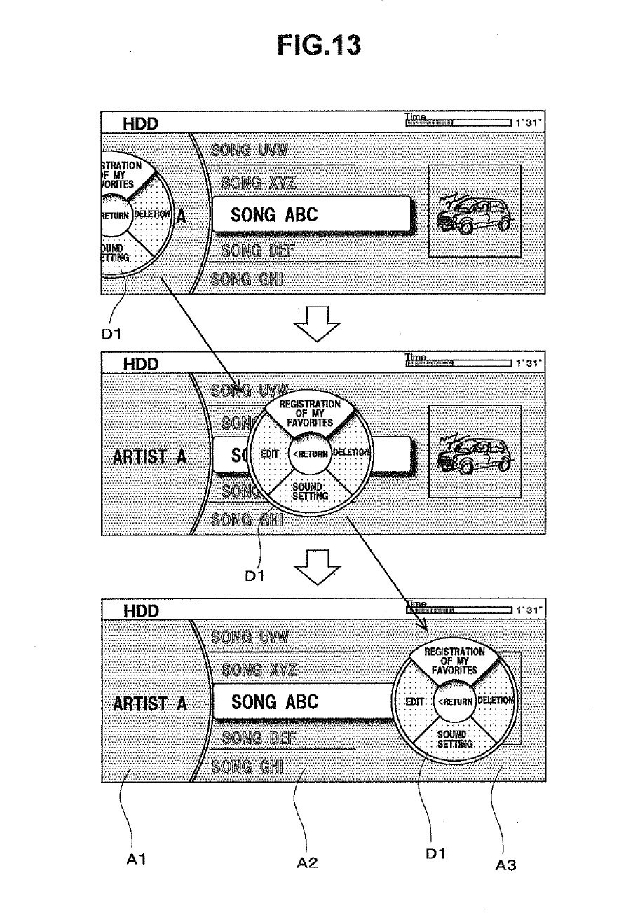

FIG. 13 is a diagram showing an example of the animation. The command panel D1 enters the screen of the display 3 from a left end of the screen by the direction operation to the right. After that, the command panel D1 moves on the screen to the right same as the direction instructed by the direction operation and stops at a predetermined position in the right area A3. In this state, when the direction operation to the left is done, the command panel D1 moves on the screen of the display 3 to the left and disappears from the left end of the screen, and the display of the command panel D1 is cancelled.

The animation in which the command panel D1 enters the screen from the left allows a user to intuitively understand that the direction operation to the left cancels the displaying of the command panel D1.

The example mentioned above is a case of specifying an item in the song title category. However, even in a case where items of the general attribute category or the sub-attribute category are displayed, a command panel including a plurality of items representing commands relating to an item selected by the cursor C may be displayed for specifying an item selected. A plurality of items representing commands in such a case may include “Edit” for editing the name of an item and “Deletion” for deleting an item.

<2-4. Other Direction Operations>

When a user specifies an item included in the hierarchical category structure, by an upward direction operation or downward direction operation of the main controller 50, a command panel different from the command panel D1 is displayed.

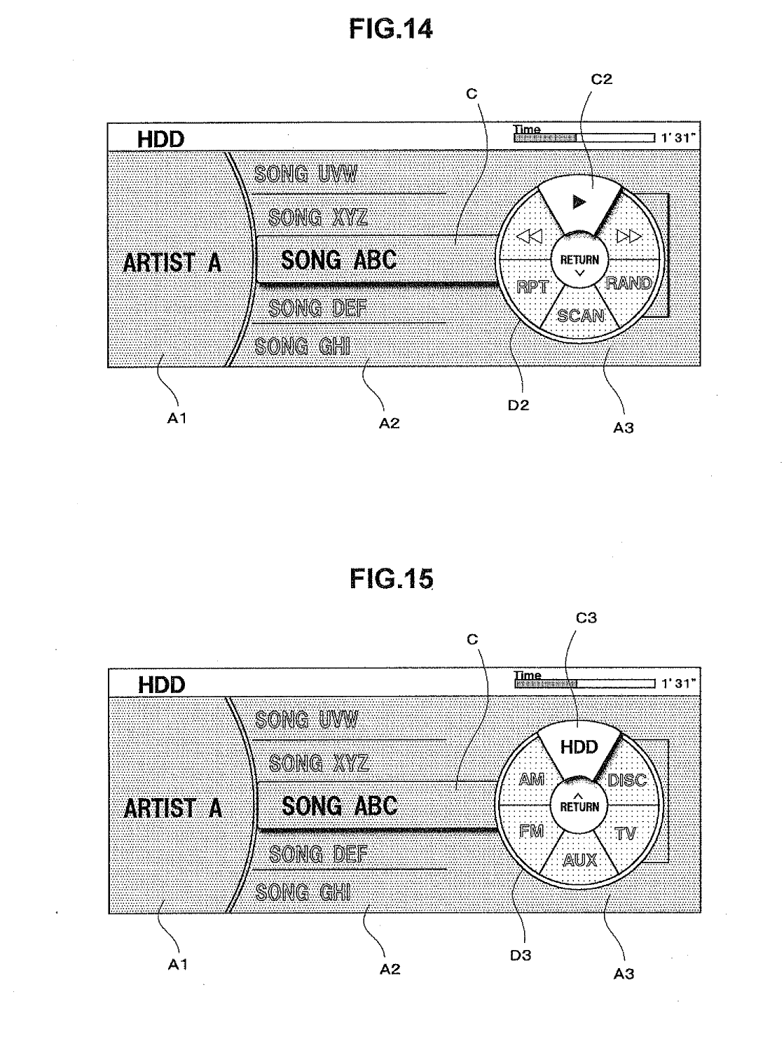

FIG. 14 is a diagram showing a screen displayed by an upward direction operation of the main controller 50. In this case, a command panel D2 including a plurality of items representing commands is displayed in the right area A3 on the screen with brightness in an entire area including an area of an item selected by the cursor C, being reduced.

The command panel D2 is also referred to as an “operation panel” and allows a user to implement an operation related to playing of audio data by specifying an item. The command panel D2 includes items respectively representing operation commands related to playing of audio data such as “play,” “forward,” “rewind,” “random,” and “repeat.”

As for the command panel D2, a cursor C2 is moved by the turning operation of the main controller 50, and an item selected by the cursor C2 is determined by the pressing operation of the main controller 50. When the item is determined, a command represented by the item determined is received by the instruction receiver 12 and executed by the controller 1.

When the command panel D2 appears, the command panel D2 enters the screen of the display 3 from a bottom end of the screen and moves upward. And then, displaying of the command panel D2 is cancelled by a downward direction operation, opposite to the upward direction operation for displaying the command panel D2.

FIG. 15 is a diagram showing a screen displayed by the downward direction operation of the main controller 50. In this case, a command panel D3 including a plurality of items representing commands is displayed in the right area A3 on the screen with brightness in an entire area including an area for an item selected by the cursor C, being reduced.

The command panel D3 is also referred to as a “source panel” and allows a user to change a source of audio data to be played by specifying an item. The command panel D3 includes items respectively representing sources to be played, such as “HDD,” “DISC,” “AM,” “FM,” and “TV.”

As for the command panel D3, a cursor C3 is moved by the turning operation of the main controller 50, and an item selected by the cursor C3 is determined by the pressing operation of the main controller 50. When the item is determined, a command to change to a source represented by the item determined is received by the instruction receiver 12 and executed by the controller 1.

When the command panel D3 appears, the command panel D3 enters the screen of the display 3 from a top end of the screen and moves downward. And then, displaying of the command panel D3 is cancelled by the upward direction operation, opposite to the downward direction operation for displaying the command panel D3.

When a user specifies an item included in the hierarchical category structure, by the direction operation to the left of the main controller 50, the cursor C is moved to the immediate upper category. Therefore, the direction operation to the left changes the state where an item in the song title category can be specified to the state where an item in the sub-attribute category can be specified. The direction operation to the left changes the state where an item in the sub-attribute category can be specified to the state where an item in the general attribute category can be specified. An item having been specified in an upper category can be changed to another by this operation.

In this embodiment, by the upward direction operation or the downward direction operation of the main controller 50, a command panel is displayed. However, the upward direction operation or downward direction operation may change an item in an immediate upper category to another.

<2-5. Operation Flow>

As mentioned above, when the user specifies an item included in the hierarchical category structure, he/she can give a variety of instructions only using the main controller 50. Based on a user operation to the main controller 50, each of those instructions is judged and received by the instruction receiver 12.

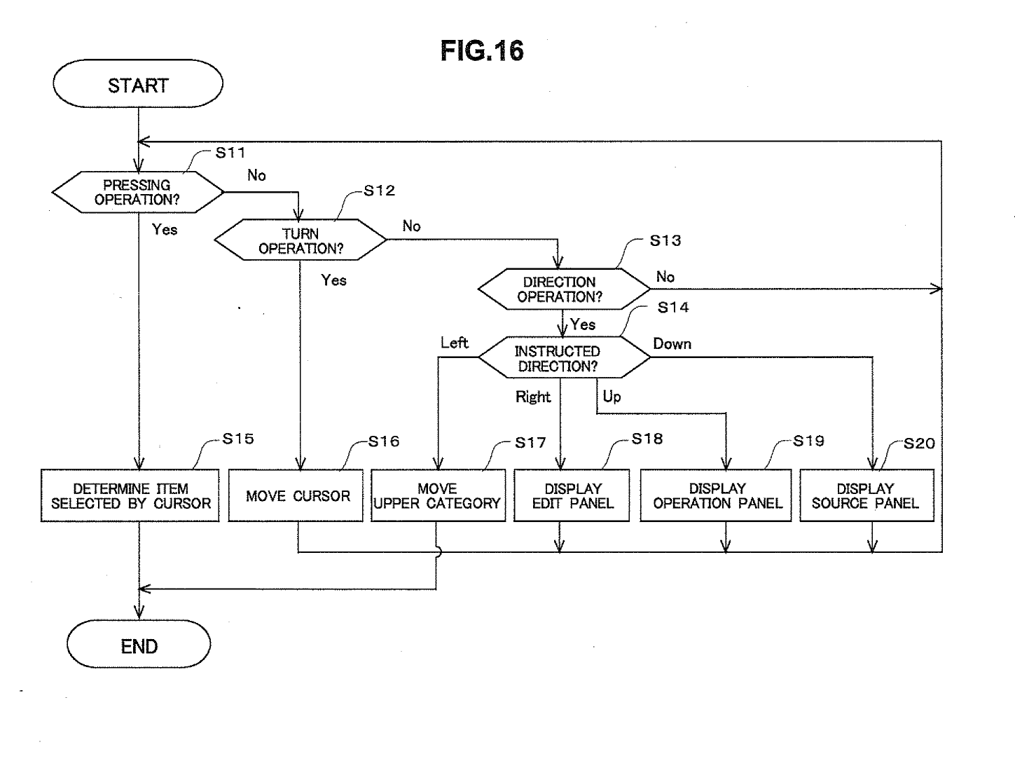

FIG. 16 is a diagram showing a flow of receiving a user instruction based on a user operation to the main controller 50. This process is executed by the instruction receiver 12 in each category of the hierarchical category structure.

In this process, it is judged whether each of user operations of the pressing operation, the turning operation and the direction operation to the main controller 50 has been implemented (steps S11, S12 and S13). When it is judged that one of those operations has been implemented, a user instruction corresponding to the operation implemented is executed.

When the pressing operation of the main controller 50 is implemented (Yes at the step S11), an item selected by the cursor C at the time is determined and the process ends. In a case of the general attribute category or the sub-attribute category, the state moves to a lower category of the item determined. In a case of the song title category, audio data corresponding to the item determined is played (a step S15).

When the turning operation of the main controller 50 is implemented (Yes at the step S12), the cursor C is moved relatively to a plurality of items to be candidates for specifying, according to a direction of the turning operation. As a result, an item selected by cursor C is changed (a step S16).

When the direction operation of the main controller 50 is implemented (Yes at the step S13), an instructed direction of the direction operation is subsequently judged (a step S14). In a case of the direction operation to the left, by the direction operation the state is moved to an immediate upper category (a step S17), and the process ends.

In a case of the direction operation to the right, the edit panel D1 is displayed (a step S18). The edit panel D1 will remain displayed until an instruction to cancel displaying of the edit panel D1 is given or an item representing a command is specified. When an item representing a command is specified, the command represented by the item specified is executed.

In a case of the upward direction operation, the operation panel D2 is displayed (a step S19). The operation panel D2 will remain displayed until an instruction to cancel displaying of the operation panel D2 is given or an item representing a command is specified. When an item representing a command is specified, the command represented by the item specified is executed.

In a case of the downward direction operation, the source panel D3 is displayed (a step S20). The source panel D3 will remain displayed until an instruction to cancel displaying of the source panel D3 is given or an item representing a command is specified. When an item representing a command is specified, the command represented by the item specified is executed.

As described above, as for the in-vehicle display system 100, in a case of specifying one of a plurality of items, the direction operation is available for displaying items representing commands relating to the item selected, in addition to the pressing operation for determining an item selected. Therefore, a user can easily give one of the commands related to the item. As a result, even when the operation unit 5 is disposed in the cabin separately from the display 3, high operability is ensured.

In addition, a selection instruction is assigned to the turning operation, a determination instruction is assigned to the pressing operation, and an instruction for displaying commands (“display instruction”) relating to an item selected is assigned to the direction operation. Since each instruction assigned to each of those operations matches the sense of a user, the user can operate the in-vehicle display system 100 intuitively.

<2-6. Displaying of Operation Guide>

As explained above, as for the in-vehicle display system 100, various instructions can be given only using the main controller 50, which provides high operability to a user experienced in an operation. On the other hand, a user inexperienced in an operation may be confused by the capability of the main controller 50 with which various instructions can be given.

In order to prevent the confusion of a user, an operation guide showing available operations at each step is displayed on the display 3 for the user inexperienced in an operation. Such an operation guide is displayed under control of the display controller 11.

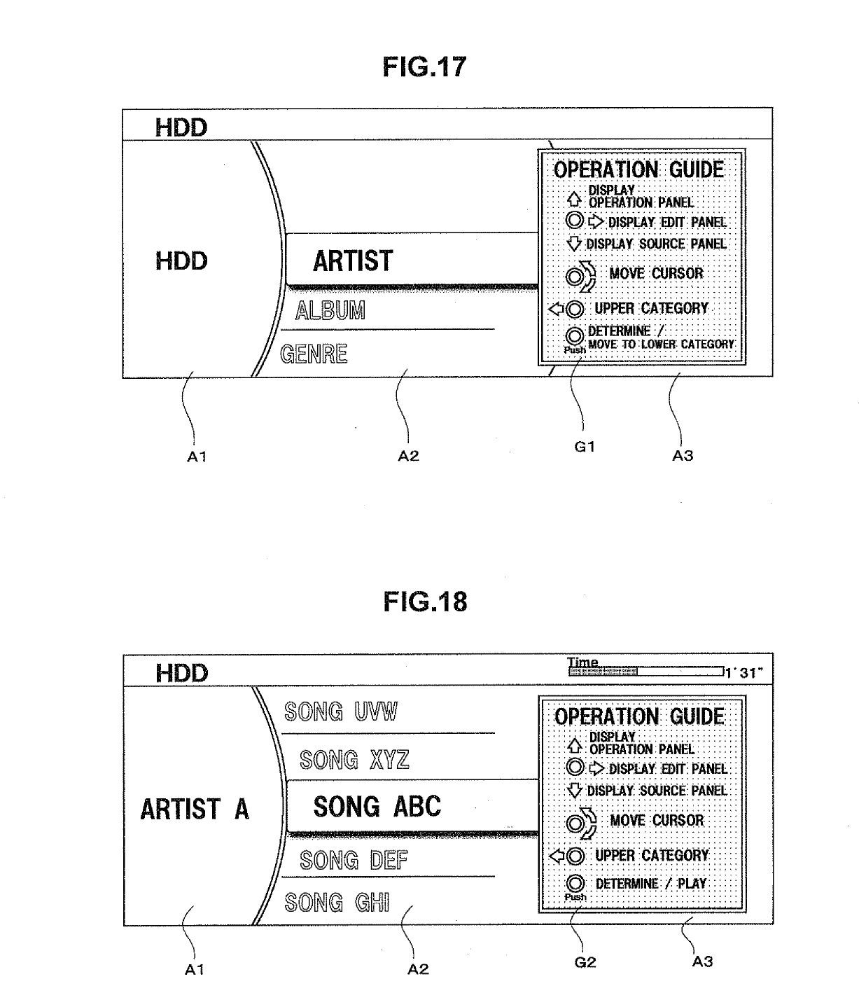

FIG. 17 is a diagram showing an exemplary screen displaying an operation guide G1 to specify an item in the general attribute category.

The operation guide G1 is displayed overlapped with the contents displayed in the right area A3. The operation guide G1 includes an explanation of each operation of the main controller 50, of the turning operation, the pressing operation and the direction operation to each of four directions. For example, “determine/move to lower category” is displayed as an explanation of the pressing operation. When the user sees the explanation displayed, he/she easily understands that the pressing operation is for determining an item selected by the cursor C and then moving to the lower category of the item determined.

It is desirable that an area where the explanation of the operation guide G1 is indicated should be semi-transparent so that contents originally displayed in the right area A3 can also be read. Moreover, a display area for the operation guide G1 is surrounded with a rectangular surrounding frame, different from the command panel mentioned above surrounded with a circular surrounding frame. By a difference in shape of the surrounding frame between the command panel and the operation guide, the user can intuitively understand which is displayed: the command panel or the operation guide

The explanation contents of the operation guide G1 is changed according to available operations at the time. FIG. 18 is a diagram showing an exemplary screen showing an operation guide G2 to specify an item in the song title category. In a case of specifying an item in the song title category, the state is not moved to a lower category by the pressing operation. Therefore, in this case, “determine/play” is displayed as an explanation of the pressing operation in the operation guide G2. When the user sees the explanation displayed, he/she easily understands that the pressing operation is for determining an item selected by the cursor C and then playing an audio data of the item determined. As described above, an appropriate operation guide can be provided to the user inexperienced in an operation by changing the explanation contents of the operation guide according to available operations.

Such an operation guide helps the user inexperienced in an operation improve the operability but frustrates the user experienced in an operation. Whereas the user experienced in an operation often starts an operation shortly after touching the main controller 50, the user inexperienced in an operation often cannot start an operation immediately after touching the main controller 50 because he/she does not know an operation method. Therefore, the operation guide is displayed only in a case where there has been no user operation to the main controller 50 for more than a predetermined period of time after a user touch to the main controller 50 being detected.

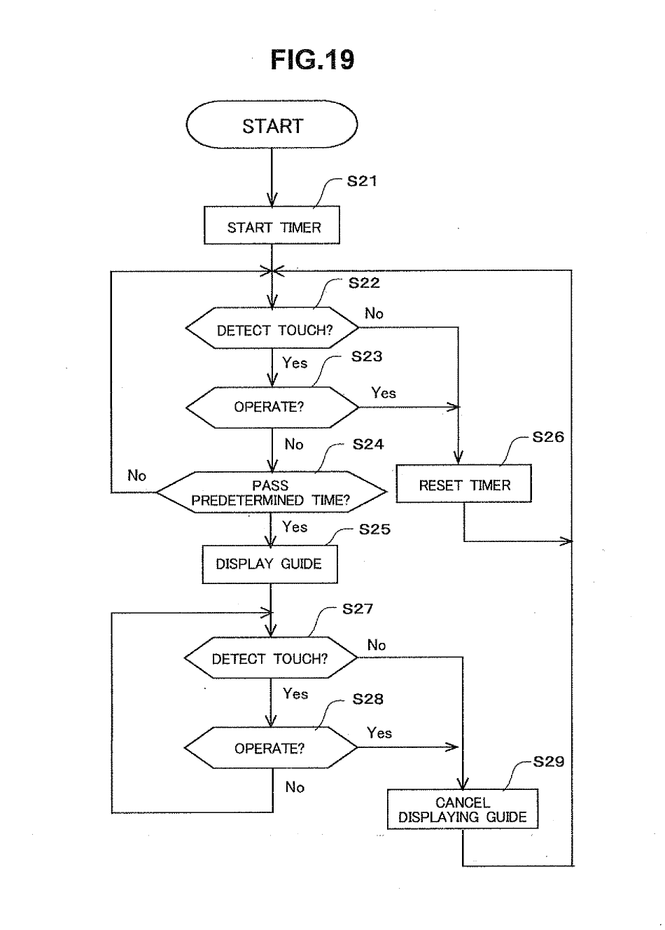

FIG. 19 is a flowchart showing a process for displaying the operation guide. This process is executed by the display controller 11 in each category of the hierarchical category structure.

First, an internal timer in the controller 1 starts to measure time (a step S21). After that, it is judged respectively whether a user touch to the main controller 50 is being detected (a step S22) and whether there has been a user operation to the main controller 50 (a step S23). Presence of the user touch is judged based on a signal input from the touch sensor 54 in the main controller 50. When user touch is not being detected (No at the step S22) or when there has been a user operation (Yes at the step S23), time measurement by the internal timer is reset (a step S26).

On the other hand, in a case where there has been no user operation of the main controller 50 (No at the step S23) with a user touch to the main controller 50 being detected (Yes at the step S22) for more than a predetermined period of time (for example one second) (Yes at a step S24), the operation guide is displayed on the screen of the display 3 (a step 525).

When the operation guide is displayed, it is again judged respectively whether a user touch to the main controller 50 is being detected (a step S27) and whether there has been a user operation of the main controller 50 (a step S28). When a user touch is not being detected (No at the step S27) or when there has been a user operation (Yes at the step S28), displaying of the operation guide is cancelled (a step S29) and the process returns to the step S22.

The operation guide is displayed in the case where there has been no user operation to the main controller 50 for more than the predetermined period of time with the user touch to the main controller 50 being detected. Since, in such a way, the operation guide is displayed for the user inexperienced in an operation of the main controller 50, the user can easily know a method for his/her desired operation and the high operability of the main controller 50 is ensured. On the other hand, since the operation guide is not displayed until the predetermined period of time passes after a user touch is detected, the operation guide is not displayed for the user experienced and able to operate the main controller 50 as soon as he/she touches the main controller 50. Therefore, the user experienced in an operation does not feel frustrated with the displaying of the operation guide.

<3. Navigation Mode>

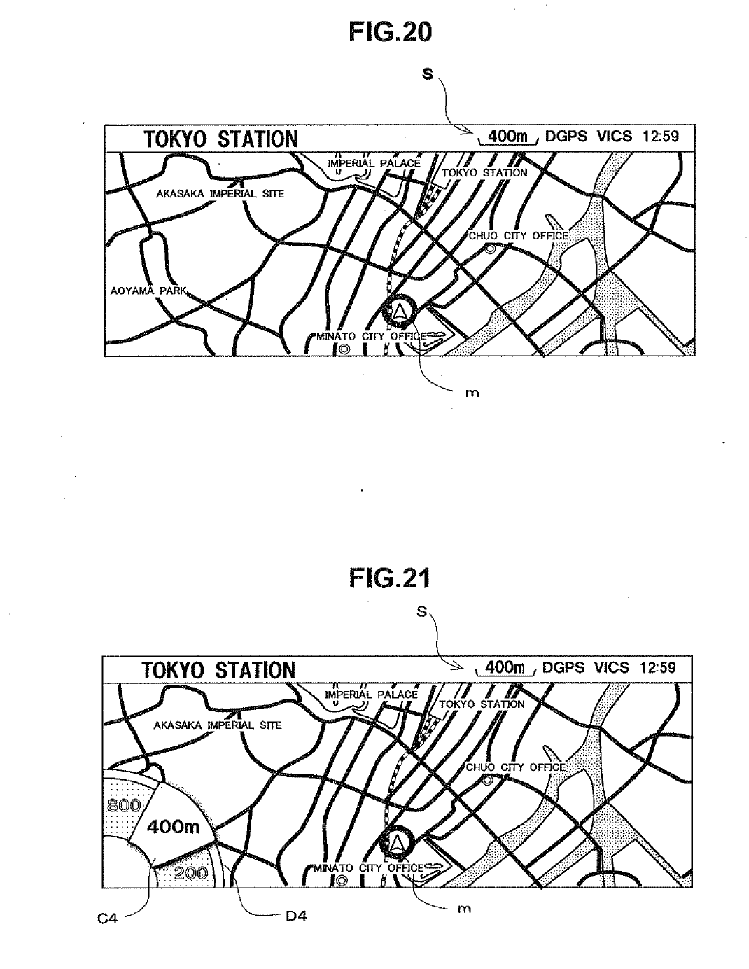

Next, a navigation mode will be explained. In the navigation mode, as shown in FIG. 20, a map image for navigation is displayed in the display 3, using functions of the navigation part 24. Approximately at a center between opposite sides of the map image, a vehicle position mark m that represents a current position of a vehicle is indicated. In an upper area of the screen of the display 3, a scale S showing a scale of the map image is displayed. When a destination is set, a route from the current position of the vehicle to the destination is overlapped on the map image, to be displayed.

Even when such a map image is displayed, a variety of instructions can be given by using the main controller 50 only. These instructions are also received by the instruction receiver 12. For example, the direction operation of the main controller 50 is received as a scroll instruction so that the map image is scrolled in an instructed direction of the direction operation.

Moreover, the turning operation of the main controller 50 is received as a user instruction to change a scale. Concretely, when the turning operation is implemented, a command panel D4, shaped like as a sector, is displayed in a bottom-left corner of the display 3, as shown in FIG. 21. The command panel D4 is also referred to as a “scale change panel.” The scale of the map image can be changed by specifying one of a plurality of items of the command panel D4. The plurality of items of the command panel D4 may be numbers, such as “50 m,” “200 m,” “400 m,” “800 m,” “3 km” and “50 km” appropriate to the scale S.

As for the command panel D4, a cursor C4 is moved by the turning operation of the main controller 50, and an item selected by the cursor C4 is determined by the pressing operation of the main controller 50. In this case, too, a hidden item can be displayed by the turning operation of the main controller 50. When an item is determined, a command to change to a scale corresponding to the item determined is received by the instruction receiver 12 and executed by the controller 1.

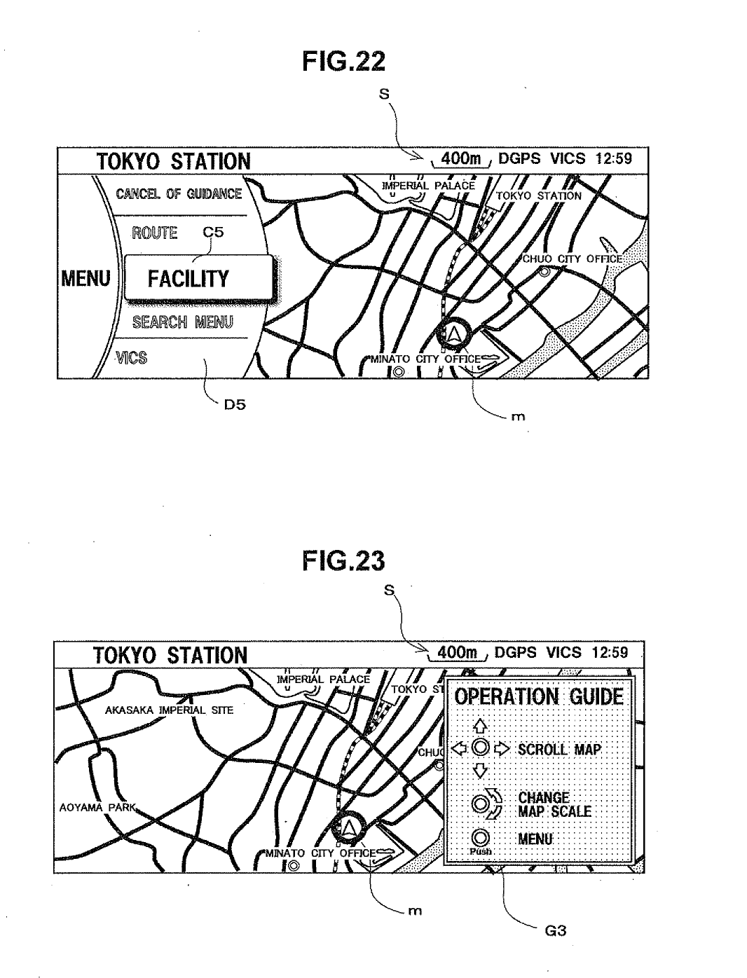

The pressing operation of the main controller 50 is received as a display instruction of a command menu. Concretely, the pressing operation causes a command panel D5 to be displayed in a left area of the display 3, as shown in FIG. 22. In this case, the map image is displayed in an area of the screen of the display 3, other than an area where the command panel D5 is displayed. A display position of the map image is adjusted to indicate the vehicle position mark m approximately at the center between opposite sides of an area displaying the map image. Therefore, the vehicle position mark m on the screen is indicated at a position on the right of the center of the screen.

The command panel D5 is also referred to as a “command menu panel.” A variation of commands related to the navigation function can be executed by specifying one of items representing commands of the command panel D5. Concrete examples of the items representing commands of the command panel D5 include “Cancel of guidance” for cancelling a route guidance, “Route” for changing a route, “Facility” for displaying the information of facilities positioned in the center of the map image, “Search menu” for searching a destination to set a route, and “VICS” for displaying VICS information.

As for the command panel D5, a cursor C5 is moved by the turning operation of the main controller 50 and an item selected by the cursor C5 is determined by the pressing operation of the main controller 50. In this case, too, a hidden item can be displayed by the turning operation of the main controller 50. When an item is determined, a command corresponding to the item determined is received by the instruction receiver 12 and executed by the controller 1.

In such a way, in the navigation mode, a variety of instructions can be given by using the main controller 50 only. Therefore, in the navigation mode, too, an operation guide showing available operations to the user inexperienced in an operation in the navigation mode is displayed on the display 3. The operation guide is also displayed in a case where there has been no user operation to the main controller 50 for more than a predetermined period of time after a user touch to the main controller 50 being detected.

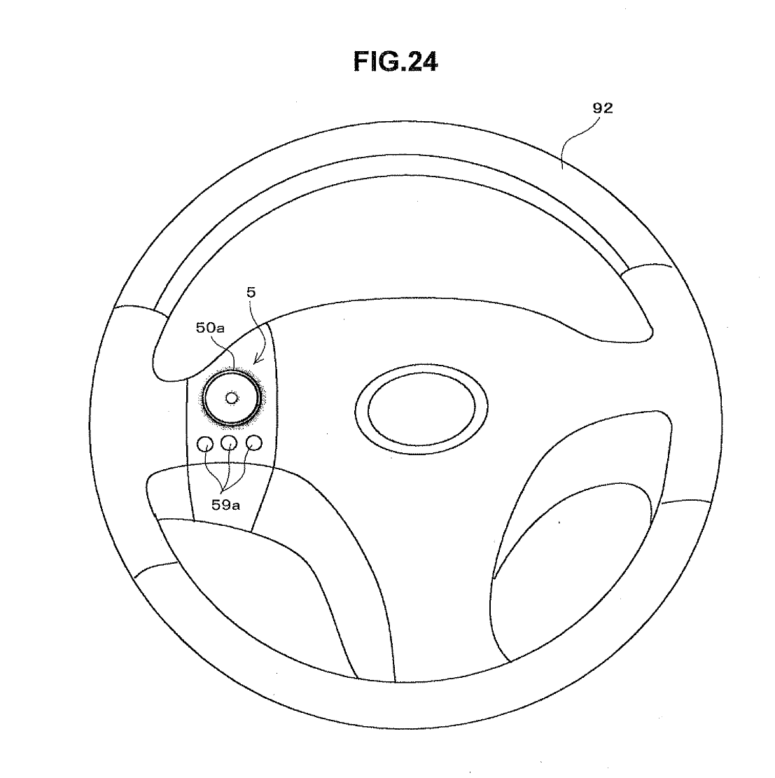

FIG. 23 is a diagram showing an exemplary screen displaying an operation guide G3 in the navigation mode. The operation guide G3 includes an explanation of each operation of the main controller 50, of the turning operation, the pressing operation and the direction operation to each of four directions. For example, “display command menu” is displayed as an explanation of the pressing operation. When the user sees the explanation displayed, he/she easily understands that the pressing operation is for displaying a command menu panel.

However, a relation between an operation of the main controller 50 and a user instruction may be different from the relation described above. For example, items representing commands related to a comprehensive navigation function may be displayed by the turning operation, and items representing commands related to a center area of the map image may be displayed by the pressing operation. The commands related to the comprehensive navigation function include commands related to route guidance, VICS information and the like. Moreover, the commands related to the center area of the map image include displaying of facility information, registering of a place to be memorized and the like. In this case, changing of a scale may be included in the commands related to the comprehensive navigation function.

<4. Modification Examples>

An embodiment of this invention was hereinbefore explained. However, this invention is not limited to the embodiment described above, and various modifications can be implemented. Hereinbelow, some of the various modifications will be explained. Each of the embodiments explained above and below can be arbitrarily combined with one or more of the others.

For example, in the embodiment described above, the center console 93 includes the operation unit 5. However, the operation unit 5 may be disposed at an arbitrary position that allows a user to easily operate the operation unit 5. For example, as shown in FIG. 24, the operation unit 5 can be disposed on the steering wheel 92. In an example shown in FIG. 24, the steering wheel 92 is equipped, on the left side the steering wheel 92, with both of a main controller 50a that allows for all of the turning operation, the pressing operation and the direction operation, and a mode switch button 59a that changes an operation mode. However, the steering wheel 92 may be equipped with the main controller 50a on the left side and the mode switch button 59a on the right side of the steering wheel 92.

Moreover, in the embodiment described above, the body part 10 includes the broadcasting receiver 21, the disc player 22, the data player 23 and the navigation part 24. One or more of them, or all of them may be separated from the body part 10 as a separate part and provided as an option function.

In the embodiments described above, a variety of functions are implemented by software performance performed by processing operation of a CPU in accordance with a program. However, a part of the functions may be implemented by an electrical hardware circuit.

While the invention has been shown and described in detail, the foregoing description is in all aspects illustrative and not restrictive. It is therefore understood that numerous other modifications and variations can be devised without departing from the scope of the invention.

What is claimed is:

1. An in-vehicle display system for installation in a vehicle, the system comprising:
a display unit for displaying information;
an operation unit disposed separately from the display unit and allowing for three types of user operations including a first operation, a second operation and a third operation; and
a receiver for receiving an instruction given by a user based on displayed contents displayed on the display unit and the user operations made with the operation unit;
wherein the receiver respectively receives:
an instruction by the first operation to select a first item from amongst a plurality of first items displayed on the display unit;
an instruction by the second operation to determine the first item selected from amongst the plurality of first items; and
an instruction by the third operation to display a plurality of second items representing commands relating to the first item selected from amongst the plurality of first items.

2. The in-vehicle display system according to claim 1, wherein
the display unit displays the plurality of second items in response to the third operation.

3. The in-vehicle display system according to claim 2, further comprising:
a controller for executing a command of a second item from amongst the plurality of second items which is specified by the user.

4. The in-vehicle display system according to claim 2, wherein
the display unit displays the plurality of second items in animation in which the plurality of second items move into a screen of the display unit from one direction.

5. The in-vehicle display system according to claim 4, wherein
the display unit cancels the display of the plurality of second items, in response to a direction operation in the one direction of the operation unit, after displaying the plurality of second items.

6. The in-vehicle display system according to claim 1, wherein
the three types of user operations are a turning operation, a pressing operation and a direction operation.

7. The in-vehicle display system according to claim 6, wherein
the first operation is the turning operation,
the second operation is the pressing operation and
the third operation is the direction operation.

8. The in-vehicle display system according to claim 7, wherein
the operation unit includes an operating member allowing for all of the turning operation, the pressing operation and the direction operation.

9. The in-vehicle display system according to claim 1, further comprising
a detector for detecting a touch of the user to the operation unit and
wherein
when the detector detects the touch of the user and there is no operation of the operation unit for more than a predetermined period of time, the display unit displays an operation guide that shows available operations.

10. The in-vehicle display system according to claim 9, wherein
a surrounding frame of the plurality of second items differs in shape from a surrounding frame of the operation guide.

11. An in-vehicle display system for installation in a vehicle, the system comprising:
a display unit for displaying information;
an operation unit disposed separately from the display unit and allowing for three types of user operations including a turning operation, a pressing operation and a direction operation;
a receiver for receiving an instruction given by a user based on displayed contents displayed on the display unit and a user operation made with the operation unit; and
a detector for detecting a touch of the user to the operation unit,
wherein
when the detector detects the touch of the user and there is no operation of the operation unit for more than a predetermined period of time, the display unit displays an operation guide that shows available operations.
